(19) United States
(12) Patent Application Publication
(10) Pub. No.: US 2025/0314272 A1
(43) Pub. Date: Oct. 9, 2025

(54) SEALING DEVICE, METHOD FOR MANUFACTURING SEALING DEVICE, AND ROLLING BEARING ASSEMBLY

(71) Applicant: ILJIN GMBH, Schweinfurt (DE)

(72) Inventors: Alexander HAEPP, Schweinfurt (DE); Yong Won KIM, Schweinfurt (DE); Seong Kyu JIN, Schweinfurt (DE)

(73) Assignee: ILJIN GMBH, Schweinfurt (DE)

(21) Appl. No.: 19/245,615

(22) Filed: Jun. 23, 2025

Related U.S. Application Data
(63) Continuation of application No. PCT/EP2023/087724, filed on Dec. 22, 2023.

(30) Foreign Application Priority Data
Dec. 22, 2022 (DE) 10 2022 134 659.5

(51) Int. Cl. F16C 33/78; F16C 19/06

(52) U.S. Cl. CPC F16C 33/7823; F16C 19/06

(57) ABSTRACT

Provided is a sealing device (10) for use together with a rolling bearing to at least partially seal at least one interior space (12) of the rolling bearing from an external environment (14). The sealing device (10) includes a first carrier member (16) having a passage (20) that fluidly connects an internal space (12) of the rolling bearing and an external environment (14). The sealing device (10) also includes a ventilation means (24) having at least one accommodating body (26) and at least one membrane (28). The accommodating body (26) includes a channel (32) and completely passes through the passage (20) of the first carrier member (16). The membrane (28) is at least partially disposed in the channel (32) of the accommodating body (26). The accommodating body (26) is injection molded, and the membrane (28) is overmolded and/or laser welded to the accommodating body (26) and fixed thereto.

### CROSS-REFERENCE TO RELATED APPLICATIONS

This application is a continuation of International Application No. PCT/EP2023/087724 filed on Dec. 22, 2023, which claims priority to German Patent Application No. 10 2022 134 659.5 filed on Dec. 22, 2022, the entire contents of which are herein incorporated by reference.

### BACKGROUND

Rolling bearings are widely used for enabling relatively low friction relative motion, especially rotational relative motion. For this purpose, the rolling bearings may have at least two bearing elements and at least one rolling element, the rolling element being disposed at least partially between the first bearing element and the second bearing element. Relative motion between the first bearing element and the second bearing element is generally made possible by the rolling element rolling on the first bearing element and/or the second bearing element.

Rolling bearings often use a lubricant injected into an internal space to reduce friction and wear of the rolling bearing and/or protect the rolling bearing from corrosion. Leakage of the lubricant from the internal space needs to be prevented as much as possible. Additionally, it is advantageous to protect the internal space of a rolling bearing, in which at least one rolling element may be disposed, from the external environment, such as, for example, the ingress of liquids (for example, splashes of water) and/or solids (for example, particles). For this reason, the interiors of the rolling bearings are often isolated or sealed from the external environment by at least one seal.

However, overpressure or underpressure may occur in the closed or sealed interior for the rolling bearing. This may be caused, for example, by temperature changes, that is, a rise or fall in temperature inside the rolling bearing. However, overpressure or underpressure may negatively affect the sealing effect of the rolling bearing seal, thereby causing wear of the seal and/or increased friction.

Therefore, it may be advantageous to provide ventilation means in the rolling bearing so as to provide gas exchange between the internal space of the rolling bearing and the external environment. This allows the internal pressure to at least partially equalize with the surrounding pressure.

Various sealing devices having ventilation means to provide gas exchange between the internal space of a rolling bearing and the external environment are known in the related art. For example, sealing devices for rolling bearings are known from the documents DE 10 2018 125 104 A1, DE 10 2019 201 717 A1, DE 10 2018 121 469 A1, DE 10 2020 208 236 A1, JP 2004-052924 A and JP 2014-001801 A.

However, the sealing devices known in the related art are disadvantageous for several reasons. For example, the assembly of the known sealing devices, particularly the ventilation means, is disadvantageous. In addition, the sealing properties of known sealing devices related to ventilation means, particularly the sealing properties for ventilation means, are insufficient or require improvement. In addition, the fixation of the ventilation means and the corresponding sealing device is often inadequate. For example, there is a relatively high risk that the fixation of the ventilation means will loosen, at least in certain situations.

Therefore, it is desirable to at least partially improve at least one of the disadvantages of the sealing devices known in the related art, preferably at least one of the disadvantages mentioned above.

### SUMMARY

The present disclosure relates to a sealing device, a method for manufacturing a sealing device, and a rolling bearing assembly.

The present disclosure is for the purpose of providing a sealing device having improved characteristics and a rolling bearing having such a sealing device. Another purpose of the present disclosure is to improve a method for manufacturing this sealing device.

The above-described purpose is achieved by the sealing device according to the features of claim 1. Embodiments having further suitable additional improvements of the present disclosure are set forth in the respective dependent claims and in the description below.

A sealing device may be used together with a rolling bearing to at least partially seal at least one internal space of a rolling bearing from an external environment.

The sealing device may include at least one first carrier member capable of being fixed to a component of the rolling bearing. The fixing to the first carrier member may be provided by form fitting, force fitting and/or material fitting. For example, at least one fixing element, for example at least one screw or at least one rivet, may be provided to fix the sealing device to the first carrier member. The first carrier member may include at least one passage, for example a bore, fluidly connecting the internal space of the rolling bearing with the external environment. The first carrier member may be formed at least partly of a metal, particularly the first carrier member may be a metal member which is at least partly overmolded or coated, for example with a plastic, particularly with an elastomer.

The sealing device may include at least one ventilation means having at least one accommodating body and at least one membrane.

The accommodating body may include at least one channel. Furthermore, the accommodating body may be at least partially disposed in the passage of the first carrier member. Particularly, the accommodating body may extend to completely pass through the passage of the first carrier member. This allows the accommodating body to be fixed to the first carrier member on a relatively large area. Furthermore, the accommodating body may be fixed to a surface of the first carrier member that is disposed outside the passage. An end of the accommodating body may extend beyond the passage. This may provide a securing means corresponding to an end extending beyond the passage. For example, at least one flange that extends radially from the base body of the accommodating body and is adapted to seated on an end of the first carrier member that is disposed outside the passage when assembled may be provided. Through the interaction between the flange and the end surface of the first carrier member, the accommodating body may be reliably fixed to the first carrier member. This allows the accommodating body to be relatively safely fixed to the first carrier member. The flange may be integrally injection-molded during the injection molding process for manufacturing the accommodating body. Preferably, the accommodating body has at least two flanges, each of which extends radially from the base body of the accommodating body and is in contact with both end surfaces of the first carrier member, which are disposed outside the passage. In this way, the accommodating body may be relatively strongly and reliably fixed to the first carrier member. One of the flanges may be integrally injection molded during the injection molding process for manufacturing the accommodating body. The second flange may be provided by molding while the accommodating body is disposed in the passage of the carrier member.

The ventilation means may be disposed completely in the rolling bearing. In other words, it is preferred that the ventilation means do not form an outer boundary of the rolling bearing. This allows the ventilation means to be more effectively protected against external influences such as dust. Furthermore, the first carrier member may be disposed at least partially in the rolling bearing. In other words, it is preferred that at least a part of the first carrier member, preferably at least a part of the first carrier member on which the ventilation means are disposed, does not form the outer boundary of the rolling bearing.

The channel of the accommodating body may extend to completely pass through the accommodating body, preferably along the longitudinal axis of the channel and/or the accommodating body. The channel may have a substantially cylindrical cross section. The cross section of the channel may be substantially constant along the longitudinal axis of the channel. However, it is also contemplated that the cross section of the channel may vary along the longitudinal axis. For example, the channel may have a tapered and/or stepped profile in at least one direction of the longitudinal axis of the channel.

The membrane may be disposed at least partially in the channel of the accommodating body. By arranging the membrane in the accommodating body or in the channel of the accommodating body, the membrane may be protected from influences from the external environment and/or from the inside in the rolling bearing. For example, this may prevent the membrane from being damaged during transport of the sealing device or the rolling bearing. The membrane is preferably disposed completely in the accommodating body.

The accommodating body may be at least partially, preferably completely, injection molded. The membrane may be overmolded and/or laser welded to the accommodating body and fixed thereto. Preferably, the membrane may be overmolded and fixed during the injection molding process for manufacturing the accommodating body. This allows a connection portion between the membrane and the accommodating body to be integrated into the manufacturing process of the accommodating body. Through this, the membrane and the accommodating body can be manufactured as an integral part through an injection molding process, preferably a 2K injection molding process. Through this, the manufacturing process of fixing the membrane to the accommodating body and producing the accommodating body may be integrated into a single process. This makes it possible to efficiently and safely fix the membrane to the accommodating body.

The membrane may be configured to allow gaseous exchange between the internal space of the rolling bearing and the external environment through the channel of the accommodating body, and particularly to substantially prevent and/or reduce fluid and/or solid exchange between the internal space of the rolling bearing and the external environment through the channel under typical environmental conditions in which the bearing is used. Through this, the internal pressure may be at least partially equilibrated with the ambient pressure. Specifically, gas, particularly air, may flow from the external environment into the internal space through the membrane, for example when the inside of the rolling bearing is at a negative pressure relative to the ambient pressure. Alternatively or additionally, gas, particularly air, may be released from the internal space to the external environment through the membrane, for example when the inside of the rolling bearing is at a positive pressure relative to the ambient pressure.

By providing a connection between the membrane and the accommodating body by means of overmolding and/or laser welding, preferably by laser welding along the entire circumference of the membrane at an interface between the membrane and the accommodating body, a relatively high sealing effect, particularly for a liquid, may be achieved between the membrane and the accommodating body. For example, the related art discloses sealing devices in which the membrane is fixed to a corresponding fixing element only in a shape-fitting manner. However, particularly the sealing effect between the membrane and the corresponding fixing element may be insufficient, particularly for liquids, in the sealing device in which the membrane is fixed in a shape-fitting manner. For example, a lubricant may be used for the rolling bearing. The lubricant may include a liquid component, particularly a relatively low viscosity liquid, which may be able to escape from the rolling bearing through a gap between the corresponding fixed elements that are form-fitted to the membrane. This may occur, for example, when grease “bleeds” out of a grease-containing lubricant.

Furthermore, the connection between the membrane and the accommodating body via overmolding and/or laser welding as described in this specification is advantageous on an adhesive bond, since a lubricant such as oil and/or other material inside or on the surface of the rolling bearing may at least partially dissolve the adhesive bond.

By providing the connection between the membrane and the accommodating body via overmolding and/or laser welding, the hermeticity between the membrane and the accommodating body may be improved compared to sealing devices known in the prior art.

The term “membrane” refers to any member that is at least partially gas permeable. The membrane prevents or at least hinders solids and/or liquids from passing through the membrane. The membrane may include slots.

The accommodating body may be formed as a sleeve. Additionally, the accommodating body may have a groove formed in an inner surface of the accommodating body. The inner surface may at least partially define and/or delimit the channel of the accommodating body. The groove preferably extends at least partially, preferably completely, along a circumference of the inner surface of the accommodating body. The groove may at least partially accommodate the membrane and may preferably be configured to fix the membrane therein. This may facilitate assembly of the sealing device.

Although the sealing device according to the present disclosure is described in this specification primarily with respect to use together with rolling bearings, the sealing device according to the present disclosure may also be suitable for a variety of other applications where pressure balance between the inside of the component and the surrounding environment is or may be advantageous. For example, the sealing device may also be suitable for general use together with bearings, that is, other types of bearings than the rolling bearing.

Preferably, the accommodating body is attached to the first carrier member in a form-fitting manner. This also allows a relatively safe and simple fixing or locking of the accommodating body to the first carrier member. The form-fitting attachment may provide a secure locking or fixing in at least one direction, for example, along the longitudinal axis of the channel of the accommodating body. The form-fitting attachment between the first carrier member and the accommodating body may be provided, for example, by the flange provided on the accommodating body. The flange may be configured to be in contact with at least one surface of the accommodating body for fixing or locking the accommodating body to the first carrier member in at least one direction. However, it is also conceivable to provide a secure locking in two different directions, that is, in a plurality of directions, along the longitudinal axis of the channel of the accommodating body.

Preferably, the accommodating body is fixed to the first carrier member by forming, preferably thermoforming, the accommodating body and/or the first carrier member. The forming is preferably performed in a state where the accommodating body and the first carrier member are at least partially assembled, that is, the accommodating body is at least partially disposed in the passage of the first carrier member. During thermoforming, the accommodating body and/or the first carrier member may be mechanically shaped using thermal energy. This process is often referred to as “thermoforming” or “hot setting.” For example, the accommodating body and/or the first carrier member may be heated and mechanically deformed by applying an external force like a press. The accommodating body and/or the first carrier member may then be cooled, for example, by cooling air and/or ambient air. The accommodating body and/or the first carrier member may maintain the deformed shape due to the molding process.

By forming, preferably thermoforming, the accommodating body and/or the first carrier member, it is possible to relatively rigidly and firmly fasten the accommodating body to the first carrier member. For example, the shape and/or the dimensions of the accommodating body and/or the first carrier member may be individually adjusted. This may, for example, at least partially compensate for various component tolerances or manufacturing tolerances of the accommodating body and/or the first carrier member, which may lead to changes in the shape and/or dimensions of the accommodating body and/or the first carrier member. This may improve or strengthen the fastening of the accommodating body to the first carrier member and/or the sealing effect of the sealing device.

Preferably, the accommodating body may be molded, preferably thermoformed, such that a form-fitting connection may be formed between the accommodating body and the first carrier member. For example, the molding process forms the flange in the accommodating body, thereby providing a for-fitting connection between the accommodating body and the first carrier member in at least one direction, preferably at least one direction along the longitudinal axis of the channel of the accommodating body.

Preferably, the membrane is made of a porous material, preferably microporous material. The porous material may have a plurality of pores that are at least partially gas permeable. The pores may be formed with dimensions that make the porous material substantially impermeable to liquids and/or solids, or at least difficult for liquids and/or solids to pass through the porous material.

Preferably, the membrane is made of at least one of the following materials: expanded polytetrafluoroethylene (ePTFE), polytetrafluoroethylene (PTFE), polyethylene terephthalate (PET), ethylene tetrafluoroethylene (ETFE), silicone rubber, glass fibers, preferably silicone-coated glass fibers, and elastomers.

Preferably, the accommodating body includes at least one base body and a flange extending radially outwardly from an outer surface of the base body. Preferably, when the accommodating body is mounted in the passage of the first carrier member, the flange is configured to abut against at least one surface of the first carrier member, preferably against at least one surface of the first carrier member that is disposed outside the passage of the first carrier member. This is to prevent a movement of the accommodating body in one direction, preferably at least along the longitudinal axis of the channel of the accommodating body, preferably a translational movement and/or a rotational movement of the accommodating body, from occurring. The flange may be designed as a collar. By providing the flange which, in the mounted state, is in contact with at least one surface of the first carrier member, a form-fitting connection may be achieved in at least one direction, preferably at least along the longitudinal axis of the channel of the accommodating body.

Preferably, the flange is arranged at the first end of the accommodating body, and the second end, which is substantially opposite the first end, is formed, preferably thermoformed. The forming, preferably thermoforming, may form a flange at the second end, such that the accommodating body may be fixed to the first carrier member by the two flanges and/or the first carrier member may be disposed between the two flanges. The two flanges may be configured to apply a clamping force to the first carrier member.

Preferably, the flange has a thickness S extending in a predetermined direction along the longitudinal axis of the channel. The base body may have a wall having a wall thickness Y extending from an inner surface of the base body defining the channel to the outer surface of the base body. Preferably, 0.75×Y<S<1.25×Y applies. The wall of the base body may at least partially define or demarcate the channel. By providing a ratio between a thickness of the flange and the wall thickness of the base body, particularly by limiting the thickness of the flange with respect to the wall thickness of the base body as defined above, a relatively high clamping force may be achieved between the flange and the corresponding surface of the first carrier member on which the flange is placed in the assembled state. For example, when the thickness of the flange is relatively thiner than the wall thickness of the base body, the flange may deform or at least deform more easily, thereby providing a relatively high clamping force between the flange and the first carrier member. For example, as described above, the flange may be disposed at a first end of the accommodating body, and a second end substantially opposite the first end may be formed, preferably thermoformed. The forming, preferably thermoforming, forms the flange at the second end such that the accommodating body may be fixed to the first carrier member between the two flanges. The two flanges may be configured to apply a clamping force to the first carrier member.

Preferably, the base body has the wall thickness Y extending from the inner surface of the base body defining the channel to the outer surface of the base body. Preferably, the flange has a height X extending radially outwardly from the outer surface of the base body. Preferably, Y<X is satisfied. By limiting the wall thickness of the base body to the height of the flange as defined above, that is, by ensuring that the wall thickness of the base body is not greater than the height of the flange, a relatively high clamping force may be caused between the flange and the corresponding surface of the first carrier member on which the flange is placed in the assembled state.

Preferably, the base body has the wall thickness Y extending from the inner surface of the base body defining the channel to the outer surface of the base body. Preferably, the membrane is disposed in the passage of the first carrier member at a minimum mounting distance Z from the outer end surface of the accommodating body. Preferably, 0.1×Y<Z and/or Z>0.3 mm, preferably Z>0.4 mm, more preferably Z>0.5 mm, even more preferably Z>0.7 mm. This ensures a minimum distance between the membrane and the outer end surface of the accommodating body. This may protect the membrane against damage, for example, during transport of the sealing device and/or the rolling bearing. The outer end surface of the accommodating body may be directed towards the periphery of the rolling bearing or towards the interior of the rolling bearing. The minimum mounting distance is defined as the shortest distance between the membrane and the outer end surface of the accommodating body. The minimum mounting distance is preferably determined along the longitudinal axis of the channel of the accommodating body. The outer cross section of the accommodating body is preferably located in a plane extending transversely to the longitudinal axis of the accommodating body.

The first carrier member may be rotatably fixed in the operating state of the rolling bearing. For example, the first carrier member may be connected to a stationary component of the rolling bearing, for example an outer bearing ring of the rolling bearing. The first carrier member may be directly connected to the stationary component of the rolling bearing. At least one second bearing element, which may be a part of the sealing element as described in this specification, may be rotatably fixed in the operating state of the rolling bearing relative to the first carrier member. For example, the second carrier member may be connected to an (operating) rotating component of the rolling bearing, for example an inner bearing ring of the rolling bearing. Alternatively or additionally, the first carrier member and/or the second carrier member may be at least partly made of a metal.

The first carrier member may overlap the outer bearing ring and/or the inner bearing ring in the longitudinal cross section of the bearing, for example axially along the longitudinal axis of the bearing. In other words, the first carrier member may overlap the outer bearing ring and/or the inner bearing ring in the longitudinal cross section of the bearing with respect to the radial direction relative to the longitudinal axis of the bearing. The first carrier member may be disposed at least 70%, at least 90%, or preferably even completely in the outer bearing ring and/or the inner bearing ring in the longitudinal cross section of the bearing.

The second carrier member may overlap the inner bearing ring and/or the outer bearing ring in the longitudinal cross section of the bearing, for example axially along the longitudinal axis of the bearing. The second carrier member may be disposed at least 70%, at least 90%, or preferably even completely in the inner bearing ring and/or the outer bearing ring in the longitudinal cross section of the bearing.

The base body preferably has a maximum outer dimension D which extends transversely to the longitudinal axis of the channel. The channel preferably has a minimum inner dimension E which extends transversely to the longitudinal axis of the channel. Preferably, E<0.5×D, more preferably 0.25×D<E<0.5×D. Furthermore, this enables a relatively high clamping force to be achieved between the flange and the corresponding surfaces of the first carrier member on which the flange is seated in the assembled state. Furthermore, this enables the channel dimensions of the accommodating body to be limited to the maximum outer dimension D of the base body. This enables, for example, the maximum gas flow through the channel to be limited to the maximum outer dimension D of the base body. Furthermore, the risk of liquids and/or particles penetrating into the rolling bearing may be reduced.

The base body and the flange are preferably formed as one piece.

Preferably, the flange is formed by forming, preferably by thermoforming, with the accommodating body assembled in the passage of the first carrier member.

Preferably, the flange is sealed, preferably at least lighit-tightly sealed, against the first carrier member.

Preferably, the accommodating body and/or the membrane is made of at least one plastic.

Preferably, the first carrier member is formed as an integral and/or single member.

Preferably, the membrane has a thickness of 100 μm or less, preferably 80 μm or less, preferably 60 μm or less, 40 μm or less, preferably 35±2.5 μm or less. The present disclosers surprisingly found that a configuration of a membrane having a thickness according to the above-defined values, for example 100 μm or less, makes it possible to achieve an optimized ratio between the fitability of the membrane and the strength of the membrane, particularly when the membrane is overmolded onto the accommodating body.

Preferably, the membrane is semi-permeable. Preferably, the membrane is permeable or substantially permeable to a medium (for example, air) and impermeable or substantially impermeable to liquids (for example, water, oil and/or sludge) and/or solids (for example, dust).

Preferably, the membrane has a plurality of pores extending through the membrane and being at least partially gas permeable, the pore size of each pore being preferably from 0.1 μm to 20 μm, preferably 1±0.8 μm, more preferably 1±0.3 μm, even more preferably 1±0.3 μm. Through the pores having such dimensions, a gaseous medium, for example, air, may pass through the pores, while other media, particularly other media from the external environment, such as solids (for example, particles and/or sludge) and/or liquids and/or viscous media (for example, oil or sludge), may be at least partially blocked by the membrane to prevent or at least reduce their penetration into the rolling bearing. The size of the pores may be understood as diameter or equivalent diameter.

Preferably, the membrane is disposed at least partially, preferably completely, outside the passage of the first carrier member, preferably on the side facing the inside or the external environment of the passage. In other words, the first part of the accommodating body, to which the membrane is attached, may be disposed outside the passage of the first carrier member. At least the second part of the accommodating body may be disposed inside the passage or extend through the passage. In this way, the attachment of the membrane to the accommodating body may be designed more flexibly, that is, with less constraints, and/or may be designed more robustly. For example, the membrane may be attached to the accommodating body using a larger area and/or more material than when the membrane were attached to the accommodating body in the passage of the first carrier member. Particularly, the material of the accommodating body that is capable of being used to attach the membrane in the passage of the first carrier member may be limited by suitable dimensions of the passage of the first carrier member, for example, the diameter.

Preferably, the sealing device is configured such that, when the sealing device is mounted on the rolling bearing, the membrane is completely disposed inside the rolling bearing, preferably inside the bearing ring, preferably inside the outer bearing ring and/or the inner bearing ring of the rolling bearing. As a result, the rolling bearing with the sealing device mounted thereon may be designed relatively compactly, and the sealing device and/or the membrane may be more effectively protected against external influences such as dust, moisture/liquids as well as against damage or transport damage.

Preferably, the first carrier member is disposed at least partly, preferably completely, in front of the membrane with respect to the direction towards the inside of the rolling bearing. Alternatively or additionally, the sealing device includes the second carrier member which is capable of being attached to a component of the rolling bearing, in which the second carrier member is disposed at least partly, preferably completely, in front of the membrane with respect to the direction towards the inside of the rolling bearing from the external environment. Through this, the membrane may be more effectively protected against external influences such as dust, moisture/liquids.

Preferably, the sealing device is configured such that a medium flowing into the sealing device from the external environment needs to bend or be bent at least once in order to reach the membrane. In other words, the sealing device may have an inflow path through which a medium flowing into the sealing device from the external environment may flow to the membrane, and this inflow path has at least one deflection and/or change of direction. In other words, the path flowing into the membrane from the external environment is preferably not linear. This also allows for more effective protection of the membrane from external influences such as dust, moisture/liquids. Thus, damage due to the use of a high-pressure washer is also prevented.

Preferably, the ventilation means, preferably the membrane, does not define the outer boundary of the rolling bearing when the sealing device is mounted on the rolling bearing.

The above-described purpose is also achieved by a method according to the features of claim 18. Advantageous embodiments with appropriate further developments of the present disclosure are set out in the respective dependent claims and in the description below. The features, exemplary embodiments and advantages described above for the sealing device similarly apply to the present method.

The method relates to a method for manufacturing a sealing device for use together with a rolling bearing to at least partially seal at least one internal space of the rolling bearing from the external environment, preferably a sealing device according to one of the embodiments described in this specification.

The present method may include one or more of the following steps:
a) a step of providing at least one carrier member capable of being fixed to a component of a rolling bearing (the carrier member having at least one passage fluidly connecting an internal space of the rolling bearing with an external environment);
b) a step of providing a ventilation means including at least one accommodating body having at least one channel and at least one membrane (the accommodating body being preferably manufactured by injection moulding, the membrane being preferably over-moulded during the injection moulding and/or secured by laser welding, such that the membrane is at least partially fixed in the channel); and
c) a step of arranging the accommodating body, preferably including the membrane connected to the accommodating body, at least partially in the passage of the carrier member, such that the accommodating body completely passes through the passage of the first carrier member, the membrane enabling gaseous exchange between the internal space of the rolling bearing and the external environment through the channel, and substantially preventing liquid exchange and/or solid exchange between the internal space of the rolling bearing and the external environment through the channel.

The present method is not limited to a particular order of the method steps. For example, it may be considered to place the accommodating body at least partially in the passage of the carrier member before the membrane is attached to the accommodating body.

The accommodating body is preferably attached to the carrier member by forming, preferably thermoforming, the accommodating body and/or the carrier member.

The accommodating body is preferably attached to the carrier element by forming, preferably by thermoforming. Preferably, the flange is formed on the accommodating body during the forming, preferably by thermoforming. The flange is preferably sealed to the carrier element, preferably in a liquid-tight manner. Alternatively or additionally, the sealing may be achieved along the cylindrical outer surface of the accommodating body.

The above-described purpose is also achieved by a rolling bearing assembly according to the features of claim 19. The above-described features, exemplary embodiments and advantages of the sealing device and of the manufacturing method apply analogously to the above-described method.

A rolling bearing assembly may comprise a rolling bearing. The rolling bearing may comprise a first bearing element, at least one second bearing element, and at least one rolling element at least partially arranged between the first bearing element and the second bearing element. The rolling bearing may be configured to allow relative motion, preferably rotational relative motion, between the first bearing element and the second bearing element by causing the rolling element to roll on the first bearing element and/or the second bearing element. Furthermore, the rolling bearing assembly may comprise at least one sealing device according to one of the embodiments described herein.

The rolling bearing assembly is preferably designed as a wheel bearing.

The following lists alternative and/or additional features of the present disclosure.

1. A sealing device used together with a bearing, preferably a rolling bearing, for at least partially sealing at least one internal space of the bearing from an external environment, the sealing device including the following components:
at least one first carrier member capable of being fixed to a component of the bearing (the first carrier member having at least one passage connecting, preferably fluidly connecting, the internal space of the bearing with the external environment); and
at least one ventilation means having at least one accommodating body and at least one membrane.
wherein, the accommodating body has at least one channel, extending to completely pass through the passage of the first carrier member.
wherein, the membrane is at least partially disposed in the channel of the accommodating body, the membrane allowing gaseous exchange between the internal space of the bearing and the external environment through the channel of the accommodating body, and substantially impeding, and preferably substantially preventing, fluid exchange and/or solid exchange between the internal space of the bearing and the external environment through the channel.

2. In the sealing device according to the first aspect, the accommodating body is injection molded, and the membrane is overmolded and fixed to the accommodating body.

3. In the sealing device according to the first aspect or the second aspect, the membrane is integrally connected to the accommodating body.

4. In the sealing device according to one of the above aspects, the membrane is integrally connected to the accommodating body without any additive.

5. In the sealing device according to the third aspect or the fourth aspect, the membrane is formed integrally with the accommodating body without any additive.

6. In the sealing device according to any one of the third to fifth aspects, an integral connection between the membrane and the accommodating body is provided by thermal deformation of the membrane and/or the accommodating body.

7. In the sealing device according to any one of the third to sixth aspects, the integral connection between the membrane and the accommodating body is provided by laser welding.

8. In the sealing device according to any one of the above aspects, the accommodating body is attached to the first carrier member in a shape-fitting manner.

9. In the sealing device according to any one of the above aspects, the accommodating body is attached to the first carrier member by forming, preferably thermoforming, the accommodating body and/or the first carrier member.

10. In the sealing device according to any one of the above aspects, the membrane is formed of a porous material.

11. In the sealing device according to any one of the above aspects, the membrane is made of at least one of expanded polytetrafluoroethylene (ePTFE), polyethylene terephthalate (PET), polytetrafluoroethylene (PTFE), ethylene tetrafluoroethylene (ETFE), a silicone rubber, a glass fiber, preferably a silicone-coated glass fiber, and an elastomer.

12. In the sealing device according to any one of the above aspects, the accommodating body includes at least one base body and a flange extending radially outwardly from an outer surface of the base body, the flange being configured to abut against at least one surface of the first carrier member, preferably at least one surface of the first carrier member arranged outside the passage of the first carrier member, when the accommodating body is mounted in the passage of the first carrier member.

13. In the sealing device according to the twelfth aspect, the flange has a thickness S extending along the longitudinal axis of the channel, and the base body has a wall thickness Y extending from an inner surface of the base body defining the channel to an outer surface of the base body, in which 0.75×Y<S<1.25×Y.

14. In the sealing device according to any one of the twelfth to thirteenth aspects, the base body has the wall thickness Y extending from the inner surface of the base body defining the channel to the outer surface of the base body, and the flange has a height X extending radially outwardly from the outer surface of the base body, in which Y<X is satisfied.

15. In the sealing device according to any one of the twelfth to fourteenth aspects, the base body has the wall thickness Y extending from the inner surface of the base body defining the channel to the outer surface of the base body, and the membrane is disposed in the passage of the first carrier member at a minimum mounting distance Z from an outer cross section of the accommodating body, in which 0.1×Y<Z is satisfied.

16. In the sealing device according to any one of twelfth to fifteenth aspects, in which the accommodating body has a maximum outer diameter D located in a plane extending transversely to the longitudinal axis, and the channel has a minimum inner diameter E located in a plane extending transversely to the longitudinal axis of the channel, in which E<0.5×D, preferably 0.25×D<E<0.5×D is satisfied.

17. In the sealing device according to any one of twelfth to sixteenth aspects, in which the base body and the flange are formed integrally.

18. In the sealing device according to any one of twelfth to seventeenth aspects, in which the flange is formed by forming, preferably by thermoforming, in a state in which it is assembled to the passage of the first carrier member.

19. In the sealing device according to any one of twelfth to eighteenth aspects, in which the flange preferably seals against the first carrier member in a fluid-tight manner.

20. In the sealing device according to any one of the above aspects, the accommodating body and/or membrane is made of at least one plastic.

21. In the sealing device according to any one of the above aspects, the first carrier member is formed integrally and/or as a single member.

22. In the sealing device according to any one of the above aspects, the first carrier member is formed at least partially, preferably entirely, of a metal.

23. In the sealing device according to any one of the above aspects, the thickness of the membrane is 100 μm or less, preferably 80 μm or less, preferably 60 μm or less, preferably 40 μm or less.

24. In the sealing device according to any one of the above aspects, the membrane has a plurality of pores extending through the membrane and having at least gas permeability, the size of each pore being preferably 0.1 μm to 20 μm.

25. In the sealing device according to any one of the above aspects, the membrane is disposed outside the passage of the first carrier member, preferably on one side of the passage facing the inside or the external environment.

26. In the sealing device according to any one of the above aspects, when the sealing device is mounted on the rolling bearing, the membrane is configured such that it is completely disposed in the rolling bearing, preferably completely disposed in the bearing ring, preferably completely disposed in the outer bearing ring and/or the inner bearing ring of the rolling bearing.

27. In the sealing device according to any one of the above aspects, at least the first carrier member is disposed at least partially, preferably completely in front of the membrane in a direction directed inwardly around the rolling bearing; and/or the sealing device includes at least one second carrier member that is capable of being fixed to a component of the rolling bearing, the second carrier member being disposed at least partially, preferably completely in front of the membrane in a direction directed inwardly around the rolling bearing.

28. In the sealing device according to any one of the above aspects, the medium flowing in from the external environment is configured such that it needs to bend or be bent at least once in order to reach the membrane.

29. In the sealing device according to any one of the above aspects, the ventilation means, preferably the membrane, does not limit the outer boundary of the rolling bearing when the sealing device is mounted on the rolling bearing.

30. In the sealing device according to any one of the above aspects, the membrane is configured to substantially prevent liquid, preferably wastewater and/or water, from flowing through the membrane.

31. A method for manufacturing a sealing member, preferably according to any one of the above aspects, for use together with a bearing, preferably a rolling bearing, which seals at least partly an internal space of the bearing from the external environment, the method including the following steps:
a) a step of providing at least one carrier member which is capable of being fixed to a component of the bearing (the carrier member having at least one passage connecting, preferably fluidly connecting, the internal space of the bearing with the external environment);
b) a step of providing at least one ventilation means including at least one accommodating body having at least one channel and at least one membrane; and
c) a step of arranging an accommodating body including a membrane connected to the accommodating body at least partly in the passage of the carrier member such that the accommodating body completely penetrates the passage of the first carrier member, the membrane allowing gaseous exchange between the internal space of the bearing and the external environment via the channel, and preferably substantially preventing liquid exchange and/or solid exchange between the internal space of the bearing and the external environment via the channel.

32. In the method according to 31th aspect, in step b) the accommodating body is manufactured by injection molding, the membrane is overmolded during the injection molding such that the membrane is at least partially fixed in the channel.

33. In the method according to 31th or 32th aspect, the accommodating body and/or the carrier member are attached to the carrier member by molding, preferably thermoforming, the accommodating body.

34. In the method according to any one of 31th to 33th aspects, the accommodating body is fixed to the carrier member by molding, preferably thermoforming, the accommodating body, in which the flange is formed on the accommodating body during the molding, preferably thermoforming, the flange being preferably at least fluid-tightly sealed to the carrier member.

35. In the method according to any one of 31th to 34th aspects, the membrane is fixed to the accommodating body by means of a material bonding connection.

36. In the sealing device according to any one of 31th to 35th aspects, the membrane and the accommodating body are formed as an integral part.

37. A rolling bearing assembly, includes: a first bearing element; at least one second bearing element; and at least one rolling element at least partially disposed between the first bearing element and the second bearing element, in which the rolling bearing is configured to allow relative motion, preferably rotational relative motion, between the first bearing element and the second bearing element by the rolling element rolling on the first bearing element and/or the second bearing element, and includes at least one sealing device according to any one of 1^{st} to 30th aspects.

38. In th rolling bearing assembly according to 37th aspect, in which the rolling bearing assembly is designed as a wheel bearing.

Additional advantages, features and details of the present disclosure will become apparent from the following description and drawings of preferred embodiments. The features and combinations of features mentioned in the above description, and the features and combinations of features mentioned in the description of the drawings below or depicted singly in the drawings, may be used not only in the individual combinations specified, but may also be used in other combinations or on their own without departing from the scope of the invention.

The membrane can be configured to allow gaseous exchange between the internal space of the rolling bearing and the external environment through the channels of the accommodating body, and particularly to substantially prevent and/or reduce fluid and/or solid exchange between the internal space of the rolling bearing and the external environment through the channels under typical environmental conditions in which the bearing is used. This allows the internal pressure to at least partially equilibrate with the ambient pressure. Particularly, gas, particularly air, can flow from the external environment into the internal space through the membrane, for example when the inside of the rolling bearing is at a negative pressure relative to the ambient pressure. Alternatively or additionally, gas, particularly air, can be released from the internal space into the external environment through the membrane, for example when the inside of the rolling bearing is at a positive pressure relative to the ambient pressure.

### BRIEF DESCRIPTION OF THE DRAWINGS

FIG. 1 illustrates a side view (schematic drawing) of a sealing device according to one embodiment of the present disclosure.

FIG. 2 illustrates a side view (schematic drawing) of a sealing device according to another embodiment of the present disclosure.

FIG. 3 illustrates a side view (schematic drawing) of a sealing device according to one embodiment of the present disclosure.

FIG. 4 illustrates a side view (schematic drawing) of a sealing device according to another embodiment of the present disclosure.

FIG. 5 illustrates a side view (schematic drawing) of an accommodating body of the sealing device of FIGS. 1 to 4.

FIG. 6 illustrates a side view (schematic drawing) of a molding process of the accommodating body of the sealing device of FIGS. 1 to 6.

FIG. 7 illustrates a (schematic) cross-sectional view of a rolling bearing assembly according to one embodiment of the present disclosure.

### DETAILED DESCRIPTION

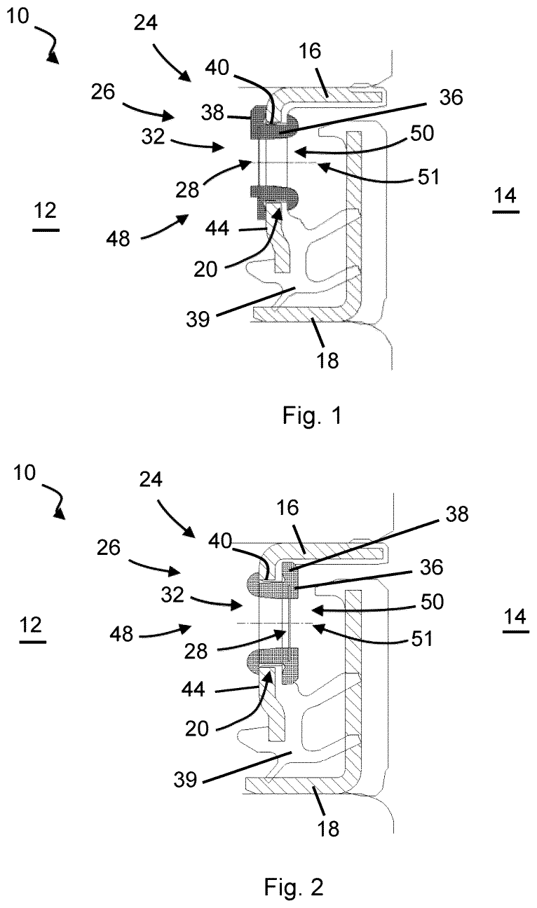

FIGS. 1 to 4 each illustrate a sealing device 10 used together with a rolling bearing (not shown in detail) to at least partially seal at least one internal space 12 for the rolling bearing from an external environment 14.

The sealing device 10 may include a first carrier member 16 and a second carrier member 18. The first carrier member 16 and/or the second carrier member 18 may be coupled to components of the rolling bearing. For example, the first carrier member 16 may be coupled to an outer bearing ring not shown, such as a fixed bearing ring, and the second carrier member 18 may be coupled to an inner bearing ring, such as a rotating bearing ring.

The first carrier member 16 may include at least one passage 20 that fluidically connects the internal space 12 for the rolling bearing and the external environment 14.

The sealing device 10 may also include at least one ventilation means 24 having at least one accommodating body 26 and at least one membrane 28.

The accommodating body 26 may have at least one channel 32. Additionally, the accommodating body 26 may be at least partially disposed in the passage 20 of the first carrier member 16. Specifically, the accommodating body 26 may extend to completely pass through the passage 20 of the first carrier member 16.

The sealing device 10 may also have a sealing element 39 configured to seal between the first carrier member 16 and the second carrier member 18. The sealing element 39 may be configured to essentially fluid-tightly seal between the first carrier member 16 and the second carrier member 18. The sealing element 39 may extend at least partially around the first carrier member 16. The first carrier member 16 may be overmolded with the sealing element 39. The first carrier member 16 may be an overmolded or vulcanized part, preferably an overmolded or vulcanized metal part.

The membrane 28 may be at least partially disposed in the channel 32 of the accommodating body 26. The membrane 28 may be configured to enable gaseous exchange between the internal space 12 for the rolling bearing and the external environment 14 through the channel 32 of the accommodating body 26, and to substantially prevent fluid exchange and/or solid exchange between the internal space 12 for the rolling bearing and the external environment 14 through the channel 32.

The accommodating body 26 may be at least partially, preferably completely, injection molded. The membrane 28 may be overmolded and fixed in the accommodating body 26, as exemplarily illustrated in FIGS. 1 and 2. Preferably, the membrane 28 may be overmolded and fixed during the injection molding process of manufacturing the accommodating body 26. As a result, the provision of a connection between the membrane 28 and the accommodating body 26 may be integrated into the manufacturing process of the accommodating body 26.

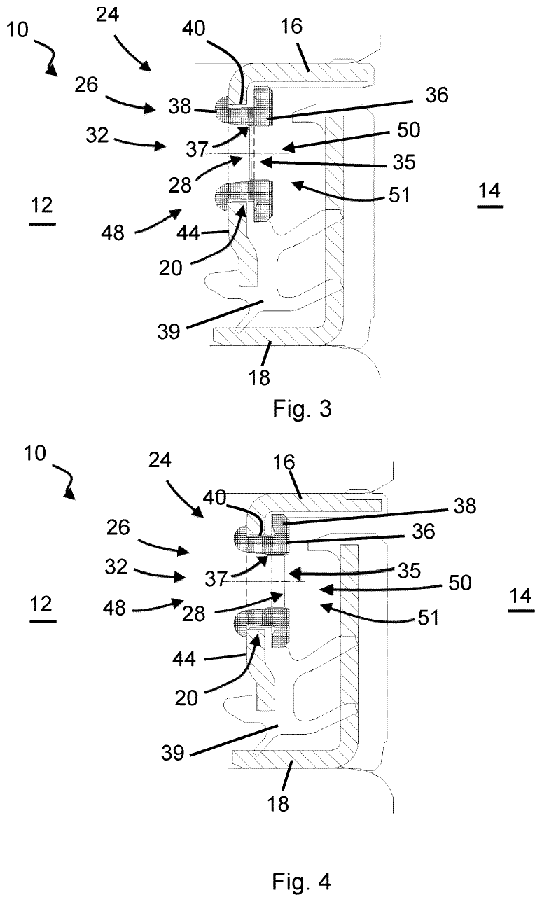

Alternatively or additionally, the membrane 28 may be laser welded to the accommodating body 26. A laser welded connection between the membrane 28 and the accommodating body 26 is illustrated, for example, in FIGS. 3 and 4. For this purpose, the membrane 28 may have a membrane base body 35 and a membrane flange 37. The laser welded connection may be provided between the membrane flange 37 and the accommodating body 26. The membrane flange 37 may extend at an angle to the membrane base body 35, preferably at a right angle. The membrane 28 may be disposed relative to the accommodating body 26 such that the membrane flange 43 extends from the membrane base body 35 toward the external environment 14, for example, as illustrated in FIG. 3. Alternatively, the membrane 28 may be disposed relative to the accommodating body 26 such that the membrane flange 37 extends from the membrane base body 35 toward the internal space 12, for example, as illustrated in FIG. 4.

The accommodating body 26 may have at least one base body 36 and a flange 38 extending radially outwardly from an outer surface 40 of the base body 36. The flange 38 may be configured to be in contact with at least one surface 44 of the carrier member 16, specifically the outer surface (refer to FIG. 1) or the inner surface (refer to FIGS. 2 to 4), when the accommodating body 26 is mounted in the passage 20 of the carrier member 16.

The membrane 28 may be positioned at a different location relative to the accommodating body 26. For example, the membrane 28 may be positioned closer to a first end 48 facing the interior space 12 than to a second end 50 facing the external environment 14, as exemplarily illustrated in FIG. 1. Alternatively, the membrane 28 may be positioned closer to the second end 50 than to the first end 48, as exemplarily illustrated in FIG. 2.

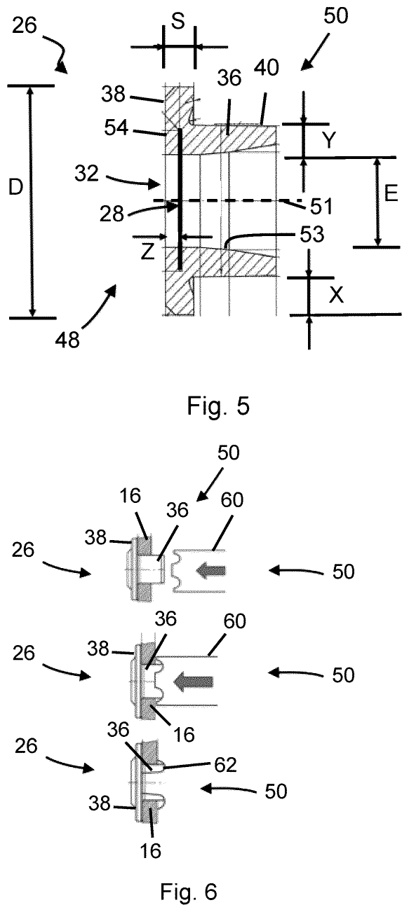

The structure of the accommodating body 26 is illustrated in more detail in FIG. 5. The flange 38 may have a thickness S extending in a direction along a longitudinal axis 51 of the channel 32. In addition, the base body 36 may have a wall thickness Y extending from an inner surface 53 of the base body 36 defining the channel 32 to the outer surface 40 of the base body 36. In addition, the following relationship may be applied between the thickness S of the flange 38 and the wall thickness Y of the base body 36: 0.75×Y<S<1.25×Y.

The wall thickness Y may taper toward an opposite end 50 of the flange 38. In other words, the wall thickness may decrease toward the opposite end 50 of the flange 38.

Alternatively or additionally, the base body 36 may have the wall thickness Y extending from the inner surface 53 of the base body 36 defining the channel 32 to the outer surface 40 of the base body 36. The flange 38 may have a height X extending radially outward from the outer surface 40 of the base body 36. Additionally, the following relationship may apply between the wall thickness Y of the base body 36 and the height X of the flange 38: Y<X.

Alternatively or additionally, the base body 36 may have the wall thickness Y extending from an inner surface 53 of the base body 36 defining the channel 32 to the outer surface 40 of the base body 36. The membrane 28 may be positioned in the passage 20 to be spaced a minimum mounting distance Z apart from an outer end surface 54 of the accommodating body 26 of the carrier member 16. Furthermore, the following relationship may apply between the wall thickness Y of the base body 36 and the minimum mounting distance Z: 0.1×Y<Z.

FIG. 6 schematically illustrates a side view of a molding process of the accommodating body 26 of the sealing device 10 for fixing the accommodating body 26 to the carrier member 16. The molding process is preferably performed in a state where the accommodating body 26 and the carrier member 16 are at least partially assembled, that is, the accommodating body 26 is at least partially arranged in the passage 20 of the carrier member 16 as illustrated in FIG. 6. Specifically, a forming tool 60, for example a pressing or punching tool, may be brought to and pressed against the second end 50 of the accommodating body 26 facing the external environment 14. Specifically, the forming tool 60 may be heated so that thermal energy may be transferred from the forming tool 60 to the accommodating body 26. This may facilitate the forming of the accommodating body 26.

The forming of the accommodating body 26 may form a second flange 62 at the second end 50 of the accommodating body 26. For example, the two flanges 38 and 62 may apply a clamping force to the carrier member 16. This may result in a relatively high tightening between the accommodating body 26 and the carrier member 16 and/or a relatively rigid fixation of the accommodating body 26 to the carrier member 16.

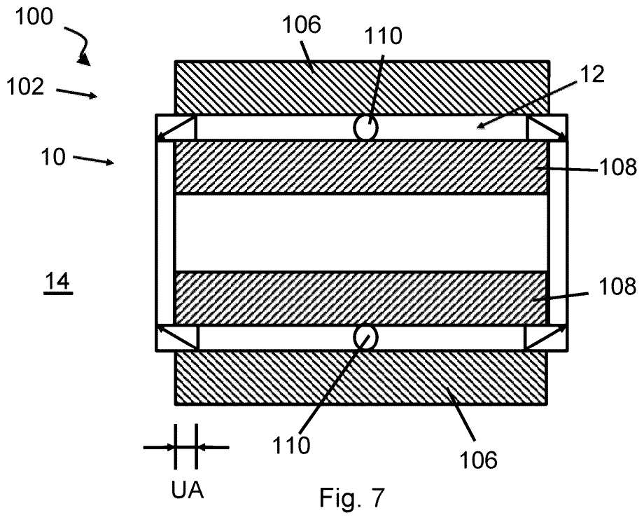

FIG. 7 is a cross-sectional view along a longitudinal axis of a rolling bearing assembly 100 and shows the rolling bearing assembly 100. The rolling bearing assembly 100 includes a rolling bearing 102 having a first bearing element (106; or bearing ring), at least one second bearing element (108; or bearing ring), and at least one rolling element (110; typically, a plurality of rolling elements), the rolling element 110 being at least partially disposed between the first bearing element 106 and the second bearing element 108. The rolling bearing 102 may be configured to allow relative motion, preferably rotational relative motion, between the first bearing element 106 and the second bearing element 108 by rolling the rolling element 110 on the first bearing element 106 and/or the second bearing element 108. The rolling bearing assembly 100 may also include at least one sealing device 10, preferably the sealing device 10 according to one of the embodiments disclosed herein (for example, the sealing device 10 illustrated in FIGS. 1 to 4), so as to substantially prevent fluid exchange and/or solid exchange between the internal space 12 for the rolling bearing 102 and the external environment 14.

As illustrated in FIG. 7, the sealing device 10 or at least the first carrier member 16 and/or the second carrier member 16 of the sealing device 10 may axially overlap the first bearing element 106 and/or the second bearing element 108 in a longitudinal cross section of the rolling bearing 102 along the longitudinal axis of the rolling bearing 102. Preferably, an overlap ratio UA of at least 70%, more preferably at least 90% may be achieved. The sealing device 10 or at least the first carrier member 16 and/or the second carrier member 18 of the sealing device 10 may also be disposed completely in the first bearing element 106 and/or the second bearing element 108, that is, in an axial direction.

The rolling bearing assembly 100 may have a single sealing device 10 or a plurality of sealing devices 10, for example, a plurality of sealing devices 10 positioned at opposite ends of the rolling bearing 102.

The rolling element 110 may be disposed in the internal space 12. The internal space 12 may extend annularly or at least partially annularly between the first bearing element 106 and the second bearing element 108, preferably around the second bearing element 108. The sealing device 10 may extend annularly or at least partially annularly along at least a part of the internal space 12.

The first bearing element 106 may be configured to be fixed to the first component, for example, by a press-fit method. The second bearing element 108 may be configured to be fixed to the second component, for example, by a shaft of the second component, preferably by a press-fit method.

The rolling bearing 102 may be designed as, for example, a wheel bearing.

What is claimed is:

1. A sealing device for use together with a rolling bearing (102), the sealing device being for at least partially sealing at least one internal space (12) of the rolling bearing (102) from an external environment (14), the sealing device (10) comprising:
at least one first carrier member (16) capable of being fixed to a component of the rolling bearing (102); and
at least one ventilation means (24) including at least one accommodating body (26) and at least one membrane (28),
wherein the first carrier member (16) includes at least one passage (20) that fluidically connects the internal space (12) of the rolling bearing (102) and the external environment (14),
the accommodating body (26) has at least one channel (32) and extends to completely pass through the passage (20) of the first carrier member (16),
the membrane (28) is at least partially disposed in the channel (32) of the accommodating body (26),
the accommodating body (26) is injection molded,
the membrane (28) is fixed by overmolding and/or laser welding in the accommodating body (26), and
the membrane (28) is configured to enable gas exchange between the internal space (12) of the rolling bearing (102) and the external environment (14) through the channel (32) of the accommodating body (26), and to substantially prevent fluid exchange and/or solid exchange between the internal space (12) of the rolling bearing (102) and the external environment (14) through the channel (32).

2. The sealing device of claim 1, wherein the membrane (28) is configured to enable gas exchange between the internal space (12) of the rolling bearing (102) and the external environment (14) through the channel (32) of the accommodating body (26), and to substantially prevent fluid exchange and/or solid exchange between the internal space (12) of the rolling bearing (102) and the external environment (14) through the channel (32).

3. The sealing device of claim 1, wherein the accommodating body (26) includes at least one base body (36) and a flange (38, 62) extending radially outwardly from an outer surface (40) of the base body (36), and
the flange (38, 62) is configured to come into contact with at least one surface (44) of the first carrier member (16), preferably at least one surface (44) of the first carrier member (16) disposed outside the passage (20) of the first carrier member (16), when the accommodating body (26) is mounted in the passage (20) of the first carrier member (16).

4. The sealing device of claim 3, wherein the flange (38) has a thickness(S) extending in a direction along a longitudinal axis (51) of the channel (32), and the base body (36) has a wall thickness (Y) extending from an inner surface (53) of the base body (36) defining the channel (32) to an outer surface (40) of the base body (36), and 0.7×Y<S<1.25×Y is satisfied.

5. The sealing device of claim 3, wherein the base body (36) a the wall thickness (Y) extending from an inner surface (53) of the base body (36) forming the channel (32) to the outer surface (40) of the base body (36), the flange (38) has a height (X) extending radially outward from the outer surface (40) of the base body (36), and Y<X is satisfied.

6. The sealing device of claim 1, wherein the first carrier member (16) is fixed to rotate during operation of the rolling bearing (102),
at least one second bearing element (108) is rotatable relative to the first carrier member (16) during operation of the rolling bearing (102), and
the first carrier member (16) is at least partially made of a metal.

7. The sealing device of claim 3, wherein the base body (36) has a wall thickness (Y) extending from an inner surface (53) of the base body (36) forming the channel (43) to the outer surface (40) of the base body (36),
the membrane (28) is disposed in the passage (20) of the carrier member (16) at a minimum mounting distance (Z) from an outer end surface (54) of the accommodating body (26),
where 0.1×Y<Z, and/or
the membrane (28) is disposed in the passage (20) of the carrier member (16) at the minimum mounting distance (Z) from an outer end surface (54) of the accommodating body (26),
where the minimum mounting distance (Z) is at least 0.3 mm, preferably at least 0.5 mm, more preferably at least 0.6 mm.

8. The sealing device of claim 3, wherein a flange (62) is formed by forming, preferably by thermoforming, while the accommodating body (26) is assembled in the passage (20) of the carrier member (16).

9. The sealing device of claim 1, wherein the accommodating body has a maximum outer diameter (D) located in a plane extending transversely to a longitudinal axis of the channel, and
the channel has a minimum inner diameter (E) located in the plane extending transversely to the longitudinal axis of the channel,
where, E<0.5×D, preferably 0.25×D<E<0.5×D.

10. The sealing device of claim 1, wherein a thickness of the membrane (28) is 100 μm or less, preferably 80 μm or less, preferably 60 μm or less, preferably 40 μm or less.

11. The sealing device of claim 1, wherein the membrane (28) has a plurality of pores extending to pass through the membrane (28) and having at least partial gas permeability, and
a pore size of each of the pores is preferably 0.1 μm to 20 μm.

12. The sealing device of claim 1, wherein the membrane (28) is disposed in a direction along a longitudinal axis of the channel and/or the bearing outside the passage (20) of the first carrier member (16), preferably on a side surface of the passage (20) facing the internal space (12) or the external environment (14).

13. The sealing device of claim 1, wherein the sealing device (10) is configured such that, when the sealing device (10) is mounted on the rolling bearing (102), the membrane (28), preferably the entire sealing device (10), is completely disposed in the rolling bearing (102), preferably in the bearing ring (106, 108), preferably in the outer bearing ring (106) and/or the inner bearing ring (108) of the rolling bearing (102).

14. The sealing device of claim 1, wherein at least the first carrier member (16) is disposed at least partially, preferably completely, in front of the membrane (28) with respect to a direction from the external environment (14) of the rolling bearing (102) toward the internal space (12), and/or
the sealing device (10) includes at least one second carrier member (18) that is capable of being attached to a component of the rolling bearing (102), in which the first carrier member (18) is disposed at least partially, preferably completely, in front of the membrane (28) with respect to the direction from the external environment (14) toward the internal space (12) of the rolling bearing (102).

15. The sealing device of claim 1, wherein the sealing device (10) is configured so that a medium flowing into the sealing device (10) from the external environment (14) is bent at least once to reach the membrane (28).

16. The sealing device of claim 1, wherein the ventilation means (24), preferably the membrane (28), does not form an outer boundary of the rolling bearing (102) when the sealing device (10) is mounted on the rolling bearing (102).

17. The sealing device of claim 1, wherein the membrane is configured to substantially prevent fluid, preferably wastewater, from flowing through and/or into the membrane.

18. A method for manufacturing a sealing device (10) for use together with a rolling bearing (102) to at least partially seal at least one internal space (12) of the rolling bearing (102) from an external environment (14), preferably the sealing device (10) according to claim 1, the manufacturing method comprising:
a) a step of providing at least one carrier member (16) that is capable of being fixed to a component of the rolling bearing (102), in which a carrier member (16) has at least one passage (20) that fluidically connects an internal space (12) of the rolling bearing (102) and an external environment (14);
b) a step of providing at least one ventilation means (24) having at least one accommodating body (26) having at least one channel (32) and at least one membrane (28), in which the accommodating body (26) is manufactured by injection molding and the membrane (28) is overmolded during the injection molding and/or fixed by laser welding so that the membrane (28) is at least partially fixed in the channel (32); and
c) a step of arranging the accommodating body (26) at least partially in the passage (20) of the carrier member (16), such that the accommodating body (26) completely passes through the passage (20) of the first carrier member (16) and the membrane (28) enables gas exchange between the internal space (12) of a rolling bearing (120) and the external environment (14) through the channel (32), while substantially preventing liquid exchange and/or solid exchange between the internal space (12) of the rolling bearing (102) and the external environment (14) through the channel (32).

19. A rolling bearing assembly that is a rolling bearing assembly (100) including a rolling bearing (102), wherein the rolling bearing (102) comprises:
a first bearing element (106);
at least one second bearing element (108);
at least one rolling element (110) at least partially disposed between the first bearing element (106) and the second bearing element (108); and
at least one sealing device (10) according to claim 1, and
the rolling bearing (102) is configured to allow relative movement, preferably rotational relative movement, between the first bearing element (106) and the second bearing element (108) by rolling the rolling element (110) on the first bearing element (106) and/or the second bearing element (108).
